(19) United States
(12) Patent Application Publication
(10) Pub. No.: US 2014/0047410 A1
(43) Pub. Date: Feb. 13, 2014

(54) Method and system for semiconductor host simulation automation

(71) Applicants: K. C. Muthukumar, Chennai (IN); V. Prasannakumar, Chennai (IN)

(72) Inventors: K. C. Muthukumar, Chennai (IN); V. Prasannakumar, Chennai (IN)

(21) Appl. No.: 13/571,354

(22) Filed: Aug. 10, 2012

(51) Int. Cl. G06F 9/44

(52) U.S. Cl. 717/106

(57) ABSTRACT

A system and method for equipment compliance testing using automation scripts is described. A development environment creates suitable DLL's from test scripts library. A script sequencer to run various test scenarios on equipment's under test, and then uses these DLLs. The DLL's are arranged and reused, in sequence by the user to create various testing scenarios. The system allows user to save the test scenario for reuse. In addition, users can modify the test scripts at runtime. The execution of the test scenarios is done using suitable communication interface and results are saved.

### TECHNICAL FIELD

This application relates to testing of equipment's factory automation compliance in semiconductor industry and more particularly to a method and system for providing dynamic arrangement of reusable test scenarios to automate the testing process.

### BACKGROUND

Semiconductor industry strictly adheres to Semiconductor Equipment and Materials International (SEMI) standards for all equipments, which are manufactured for use in the semiconductor fabrication units. Fabrication units/OEMs in different companies make use of different proprietary testing tools using high-level computer languages for testing equipment to ensure that the equipment adheres to the standards. Sometimes, even different equipment units in a same company may use different tools for compliance testing. Due to the use of proprietary languages for the testing tools, many limitations arise in the testing of equipments.

Most tools come with several built in test scenarios, which can be executed, and results shown. These tools do not allow users to modify the test scenarios such as creation of new test scenarios or change the sequence of tests/test steps being done. In addition, most tools do not allow debugging of the script used for testing. Most users require a lot a practice and time to master the propriety languages used to make any modifications in the automation scripts used for testing. In addition, complex-testing scenarios cannot be defined or reused.

### BRIEF DESCRIPTION OF THE FIGURES

The embodiments herein will be better understood from the following detailed description with reference to the drawings, in which:

FIG. 1 illustrates a block diagram showing modules involved in an equipment compliance testing, according to the embodiments as disclosed herein;

FIG. 2 is a flowchart showing a method for equipment compliance testing using a script sequencer, according to embodiments disclosed herein; and

FIG. 3 is a block diagram showing language and transport mechanism between the script sequencer module and the semiconductor equipment under test, according to embodiments disclosed herein; and

FIG. 4 illustrates a computing environment implementing the application, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

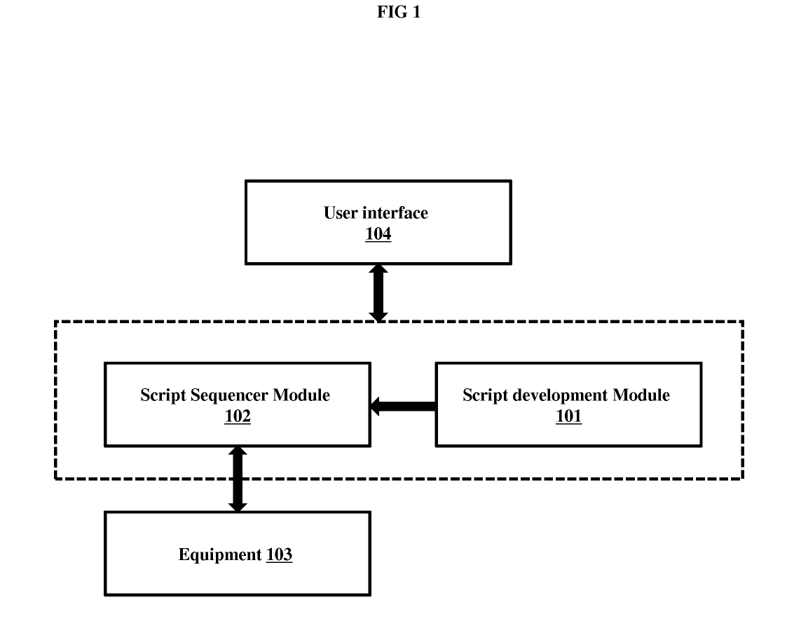

FIG. 1 illustrates a block diagram showing modules involved in an equipment compliance testing, according to the embodiments as disclosed herein. The script development module 101 and the script sequencer module 102 are the main modules involved in testing. The equipment 103 under test communicates through HSMS protocol with the script sequencer. The user interface 104 allows users to communicate with different modules. The script development module 101 comprises of an integrated development environment-IDE, which contains an HSMS library, and a script library. The script development module 101 creates complex automation test scripts. The script development module generates reusable dynamic link libraries DLLs containing automated test scripts. The scripts are written using .NET language. Full-fledged functionalities of .NET framework components enable users to build complex logics in the scripts, easily using thread, delegates, UI Framework, etc. The script sequencer module 102 then uses these dynamic link libraries DLLs. The script sequencer sequences/de-sequences DLL's to create varied test scenarios. Once a test scenario is created, it can be saved in an XML format by the user for further use. The user can execute the test scenario on equipment through a TCP/IP communication link. During runtime, the user can debug the test scenario by making suitable changes to the test script. User can develop any custom application or user interface application using Visual studio-VS IDE invoking the HSMS and script libraries. The application can be invoked from the script runner during runtime. In addition, a single script sequencer module 102 can support multiple threads. Once the test is executed, results are reported back. During execution, the user is able to debug the scripts and identified the errors involved in sending SECSII messages.

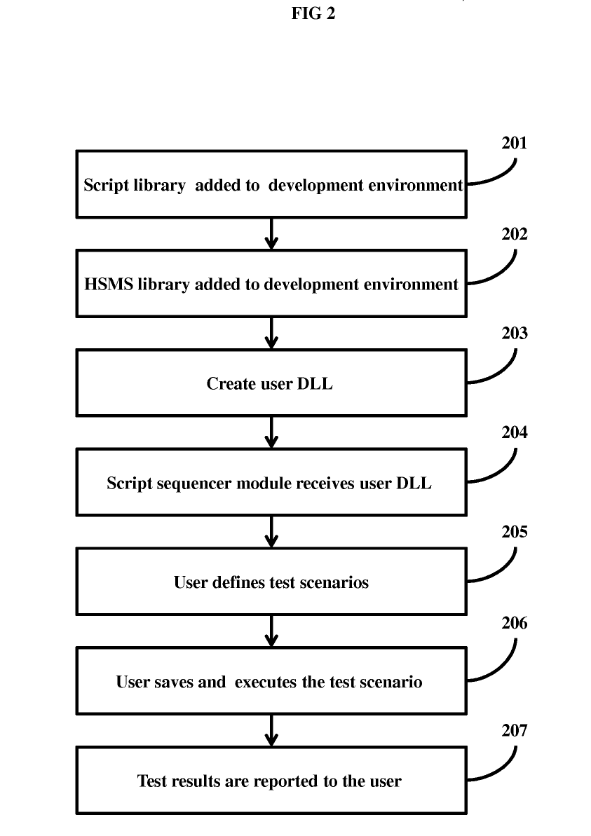

FIG. 2 is a flowchart showing a method for equipment compliance testing using a script sequencer, according to embodiments disclosed herein. In the script development module 101, scripts are added (201) to a library. Appropriate-High-Speed SECS Message Services HSMS library is also added (202) to the development environment 101 for communicating with the equipment 103. Once the development module 101 has its libraries in place, dynamic link libraries-DLL's are created (203) using the script library and the HSMS library. The DLL's are then added (204) to the script sequencer module 102. The user then defines (204) the test scenario by sequencing/de-sequencing DLL's. The DLL can be added from the development module 101 and rearranged using a drag/drop feature. Once the test scenario is created, it is saved (205) in suitable format. The test scenario can be reused as required. The test scenario is then executed (206) on the equipment and results are reported (207) back to the user interface 104. The test scenario can then be rushed multiple times for testing factory automated testing of similar equipment. The user can also debug the automated test script to change test scenario if required. The various actions in system 200 may be performed in the order presented, in a different order or simultaneously. Further, in some embodiments, some actions listed in FIG. 2 may be omitted.

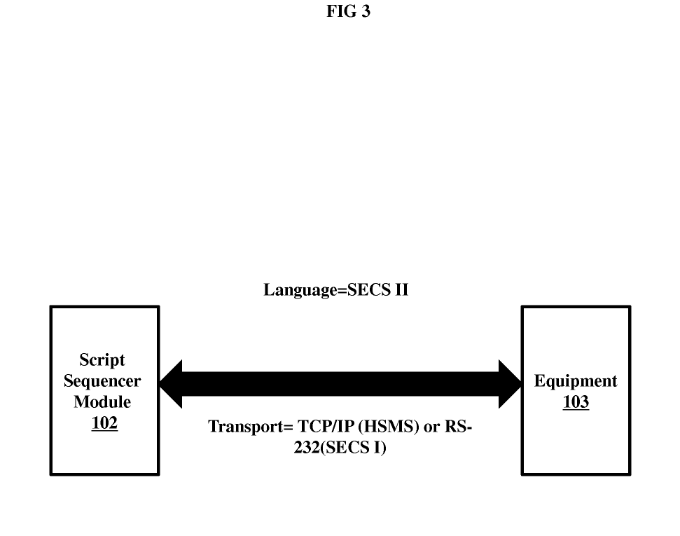

FIG. 3 is a block diagram showing language and transport mechanism between the script sequencer module and the semiconductor equipment under test, according to embodiments disclosed herein. The main language of communication between the script sequencer module and the semiconductor equipment under test is Semiconductor Equipment Communications Standard (SECS-II). The SECS-II defines the message structure between equipment and script sequencer module. The mode of communication can be TCP/IP connection. This mode allows data collection reporting, alarms, events, equipment constants between the two.

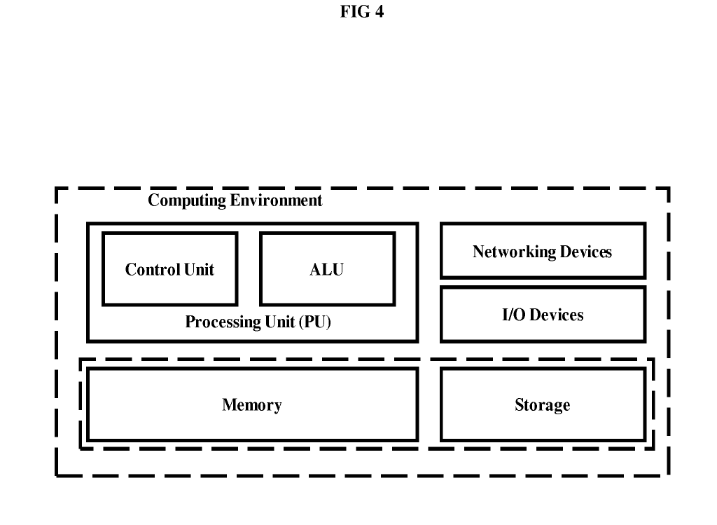

FIG. 4 illustrates a computing environment implementing the application, according to embodiments disclosed herein. As depicted the computing environment comprises at least one processing unit that is equipped with a control unit and an Arithmetic Logic Unit (ALU), a memory, a storage unit, plurality of networking devices, and a plurality Input output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, any logical and arithmetic operations involved in the execution of the instructions are computed with the help of the ALU. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations, various networking devices or external I/O devices may be connected to the computing environment to support the implementation through the networking unit and the I/O device unit.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for ensuring standards compliance in a semiconductor equipment using a script sequencer, said method comprising of:
creating a library of test scripts;
building at least one test automation script using at least one of said scripts from said library in a development environment;
creating user dynamic link library for said at least one test automation script;
defining test scenarios at runtime of said at least one automation script; and
executing said test scenarios on said semiconductor equipment.

2. The method as in claim 1, wherein said development environment allows users to modify and create test scripts.

3. The method as in claim 1, wherein said dynamic link libraries (DLLs) provides said script sequencer with various testing scripts for said equipment compliance testing.

4. The method as in claim 1, wherein said script sequencer allows users to create new testing scenarios by sequencing said dynamic link libraries (DLLs).

5. The method as in claim 1, wherein said method allows script sequencer to run multiple threads.

6. The method as in claim 1, wherein said method allows users to debug any test scenario at runtime.

7. A system for equipment compliance testing using factory automation scripting allowing usage of reusable test scenarios, wherein said system comprises of:
an integrated circuit further comprising at least one processor;
at least one memory having a computer program code within said circuit;
said at least one memory and said computer program code configured to with said at least one processor causes the system to:
create a library of test scripts;
provide a development environment to build automation scripts using suitable scripts from library and create dynamic link libraries-DLL's; and
provide a script sequencer for defining test scenarios, executing test scenarios and reporting results.

8. The system as in claim 7, wherein said development environment allows users to modify and create test scripts.

9. The system as in claim 7, wherein said dynamic link libraries-DLLs provide said script sequencer with various testing scripts for said equipment compliance testing.

10. The system as in claim 7, wherein said script sequencer allows users to create new testing scenarios by sequencing said dynamic link libraries-DLLs.

11. The system as in claim 7, wherein said method allows script sequencer to run multiple threads.

12. The system as in claim 7, wherein said method allows users to debug any test scenario at runtime.
